(19) United States
(12) Patent Application Publication
(10) Pub. No.: US 2022/0153540 A1
(43) Pub. Date: May 19, 2022

(54) Tray Supporting Device

(71) Applicant: Carsoe A/S, Aalborg Ø (DK)

(72) Inventors: Steffen Næss-Schmidt, Vodskov (DK); Thomas Andersen, Vadum (DK)

(21) Appl. No.: 17/432,141

(22) PCT Filed: Feb. 21, 2020
(86) PCT No.: PCT/DK2020/050048

§ 371 Date: Aug. 19, 2021

(30) Foreign Application Priority Data
Feb. 21, 2019 (DK) PA 2019 70110

(51) Int. Cl. B65G 59/10; B65G 43/08; B65G 59/06

(52) U.S. Cl. CPC B65G 59/103; B65G 2203/0233; B65G 59/063; B65G 43/08

(57) ABSTRACT

Support unit, constituting part of a denesting apparatus, said support unit supporting a stack (2) of trays, cups or other receptacles (10) to be denested in the denesting apparatus, such that trays, cups or other receptacles (10) are dispensed one by one from a lower part of the stack (2), where said support unit comprises two vertical guides arranged in close proximity to the stack on opposing sides of said stack, and where on each vertical guide two or more engagement pads (12, 13; 14, 15) are provided, which engagement pads are suitable to simultaneously contact a plurality of edges of the trays, cups or other receptacles (10) to be denested, in a sequential manner, such that at least one engagement pad on either side is in contact with a plurality of edges of the trays, cups or other receptacles to be denested at a time

### FIELD OF THE INVENTION

The present invention is directed to a support unit suitable to be integrated in a denesting apparatus which denesting apparatus is used for dispensing or denesting trays, cups or other receptacles particularly in the food industry.

### BACKGROUND OF THE INVENTION

Trays which are used for foodstuff are typically manufactured from a very thin polymer material. During filling of the trays in an industrial installation, the trays are traditionally inserted/loaded into a denesting apparatus which will dispend trays onto a conveyor belt after which the empty trays are transported to a filling station, filled with the desired content and finally sealed, labelled and removed from the production facility. In order to do this in an industrious manner, the trays are arranged in a denesting apparatus where a stack of trays are rapidly dispensed from the bottom of the stack onto the conveyor such that gravity will aid in the dispensing of trays.

The invention will be explained with reference to trays but it should be understood that any object which is suitable to be dispensed by a denesting apparatus is suitable to be used with the present invention. Consequently, trays, cups or other receptacles shall be understood as being comprised within the inventive concept of the present invention. However, for the sake of explaining the concept of the invention and the examples below, reference will be made to a tray but it should be understood that the invention is not limited to trays.

In the industry there are many aspects to this denesting of trays which need to be addressed and taken into account when designing and operating such device. Firstly, it is advantageous to be able to load a large number of trays into the denesting apparatus in that manual labour in this manner may be minimized. On the other hand, a large stack of for example trays will a create heavy load on the denesting wheel which is often the mechanism used to separate the lowermost tray from the stack of trays, right before the tray is guided onto the conveyor belt. For this purpose, it is common to use devices which will engage the stack of trays and lift the stack of trays a certain distance in order to lower the load on the denesting wheel and thereby facilitating a very smooth and continuous dispensing of trays onto the conveyor belt. However, the development of trays is towards trays made from an ever thinner material and where the distance between each tray in a stack is ever decreasing. Typically, the trays have an edge surrounding a cavity, and the denesting wheel for example will engage the edge and liberate the lowermost tray from the stack of trays by forcing the edge of the tray downwards relative to the stack such that an effective denesting is achieved. It is therefore clear that when the trays become thinner and thinner and are packed closer and closer together, the denesting wheel will need to operate more precisely in order to be able to engage the space between two adjacent edges on two adjacent trays in order to dispense only one tray securely. Furthermore, the thin material does provide disadvantages with the known systems of devices which will diminish the load by engaging the stack and often lifting the stack of trays in that the lifting will be carried out on the edge of one tray at the bottom of the part of the stack which it is desireable to lift. This edge will tend to bend and possibly deform the tray or let the means for gripping the stack of trays in order to be lifted slip on the edges as the edges bend away due to the very thin material thickness and thereby inherent resistance in the material.

### OBJECT OF THE INVENTION

Consequently, it is an object of the present invention to provide a system of supports which may support a very large stack of trays, cups or other receptacles to be dispensed in a denesting apparatus even when the trays are made from a very thin material and the trays are closely spaced in the stack.

### DESCRIPTION OF THE INVENTION

The invention addresses this by providing a support unit said support unit supporting a stack of trays, cups or other receptacles to be denested in the denesting apparatus, such that trays, cups or other receptacles are dispensed one by one from a lower part of the stack, where said support unit comprises two vertical guides arranged in close proximity to the stack on opposing sides of said stack, and where on each vertical guide two or more engagement pads are provided, which engagement pads are suitable to simultaneously contact a plurality of edges of the trays, cups or other receptacles to be denested, in a sequential manner, such that one engagement pad on either side is in contact with a plurality of edges of the trays, cups or other receptacles to be denested at a time.

Particularly, the fact that the engagement pads are contacting a plurality of edges of the trays is advantageous in that the forces on each edge of each tray may be kept very low such that the engagement pads do not damage or deform the trays and at the same time by engaging a plurality of edges sufficient holding force is established in order to retain and hold a very high stack of trays. As the engagement pads may be provided with a relatively large area, the distribution of force per area unit is very low but at the same time the entire force used in holding the stack may be quite considerable. In this manner the support unit may hold a very high stack of trays in a firm and secure manner.

In a further advantageous embodiment of the invention, means are provided for bringing the engagement pads into contact with the edges of the trays, cups or other receptacles to be denested, in a sequential manner, where said means in the shape of actuators are provided for each engagement pad between the vertical guide and the surface of the engagement pad facing the stack of trays, cups or other receptacles to be denested.

Particularly, by incorporating actuators in sequential manner in which the engagements pads are operated may be coordinated very precisely and particularly the pressure with which the engagement pads are engaging the edges of the trays may be determined such that a firm engagement is achieved without damaging the edge of the trays or deforming the trays all together.

In a further advantageous embodiment, the actuators are powered by hydraulic fluid or pressurized gas or electricity. These are straight forward drive means for actuators and will be chosen according to the installation in which the support unit is installed such that for example for most applications electricity is provided to the denesting apparatus as such and it may be possible to plug in the support according to the present invention directly into the electrical system provided to the denesting apparatus. Pressurized gas actuators provide a very simple and fast type of actuators and at the same time the air pressure may be very precisely controlled such that a very reliable operating support unit may be the result. In particular hydraulic fluid operated actuators are able to provide a very high pressure and may therefore be used for applications where the engagement pads shall be provided with a high engagement pressure in order to hold a very high stack of trays.

In a further advantageous embodiment of the invention, means are provided for bringing the engagement pads into contact with the edges of the trays, cups or other receptacles to be denested, in a sequential manner, where said means comprises at least one aperture in each engagement pad, where each vertical guide comprises a rotating axle, and where the axle is fitted through one aperture in each engagement pad arranged on the same side of the stack of trays, cups or other receptacles to be denested, and where a cross section of the rotating axle in the aperture has a non-circular cross-section or off-center circular section and where the non-circular cross-section or off-centered circular section is different or non-symmetrical for engagement pads arranged on the same side of the stack of trays, cups or other receptacles to be denested.

By having rotating axles fitted through apertures in the engagement pad, the off center circular sections or non-circular cross-sections of the axle adjacent the apertures through the engagement pads will provide for a reciprocating movement of the engagement pads as the axle is rotated. Such a principle is for example known from camshaft engines and the like. By offsetting the cams with respect to the different engagement pads arranged on the same camshaft it is possible to create the sequential manner of engagement by the engagement pads on the edges of the trays whereby the correct support is provided at the correct time as suggested by the concept of the present invention.

In some instances it is desirable to be able to lift the stack of trays vertically in order to free the denesting wheel or in other manners gain access to the lower part of the stack. For these reasons the support unit may be provided with a sensor which detects if the stack of trays is moved upwards whereby the vertical guides triggered by the input from the sensor moves slightly away from the stack of trays thereby allowing for easy lifting of the stack of trays. The sensor may for example be an optical sensor or a mechanical sensor for example a small wheel having fins which fins are rotated by engagement with the edges of the trays and if the direction of rotation of the wheel with fins is reversed this is an indication of the stack being lifted and consequently, the vertical guides shall be triggered to move away from the stack.

In an embodiment of the invention, the vertical guides are arranged on a support element allowing the horizontal distance between the vertical guides to be adjusted.

This allows for removing the vertical guides sufficiently such that an operator may access the support unit for cleaning, repair service and the like. Furthermore, if an upwards movement is detected as discussed above in the previous embodiment of the invention, the movement of the vertical guides away from the stack facilitates this movement.

In at still further advantageous embodiment of the invention, the surface of the engagement pads intended for engagement with the stack of trays, cups or other receptacles to be denested is provided with a resilient layer. As most trays to be denested in these types of apparatus are made from a very thin polymeric/plastic material, the edges are relatively soft. For these reasons it is advantageous to provide the engagement pads with a resilient layer such that the resilient pad upon contact with the edge is slightly deformed and thereby handles the edge of the tray and thereby the tray itself in a gentle manner. Also from the point of view that these types of trays are mass produced at very low costs the tolerances or inaccuracies from tray to tray way cause the vertical alignment of the stack to be slightly upset which again is compensated partly by the engagement pads being resilient therefore able to deform slightly such that they can compensate from the vertical alignment and still due to the provision of the resilient layer effectively engage all edges superposed the engagement pads.

In a further advantageous embodiment of the invention, the surface of the engagement pads intended for engagement with the stack of trays, cups or other receptacles to be denested is shaped corresponding to the edge of the trays, cups or other receptacles to be denested. Particularly, when the trays or cups have a rounded edge shaping, the engagement pads correspondingly assure that a larger part of the edge is engaged and thereby the pressure on the tray or cup is minimized when holding the stack of trays or cups by the engagement pads.

The invention is also directed at a method for denesting a tray, cup or other receptacle to be denested, where the denesting apparatus comprises means on which a stack of trays, cups or other receptacles to be denested are resting, said means may be a denesting wheel, where the stack of trays, cups or other receptacles to be denested are arranged in a support unit according to claim 1, where at least two engagement pads are arranged on each vertical guide, such that the first set of engagement pads is arranged at a first height and a second set of engagement pads is arranged at a second height different from the first height, and where:

In a first holding position the first set of engagement pads is in holding contact with the stack of trays, cups or other receptacles to be denested, and the second set of engagement pads is not in engagement with the stack of trays, cups or other receptacles to be denested; and a

Second holding position where the second set of engagement pads is brought into holding contact with the stack of trays, cups or other receptacles to be denested, and the first set of engagement pads is not in engagement with the stack of trays, cups or other receptacles to be denested,

where during denesting, the denesting apparatus sequentially alters between the first holding position and the second holding position.

Naturally, the inventive method incorporating the features of the inventive apparatus will solve the technical problem as described above by utilizing the inventive features of the invention in a rational method providing advantageous improvements of the prior art.

### DESCRIPTION OF THE DRAWING

The invention will now be explained with reference to the accompanying drawing in

FIG. 1 schematically illustrates a support unit

FIGS. 2 and 3 schematically illustrates two different embodiments of the engagement pads

FIG. 4 schematically illustrates a drive axle

FIG. 5 schematically illustrates various stages in denesting

### DETAILED DESCRIPTION OF THE INVENTION

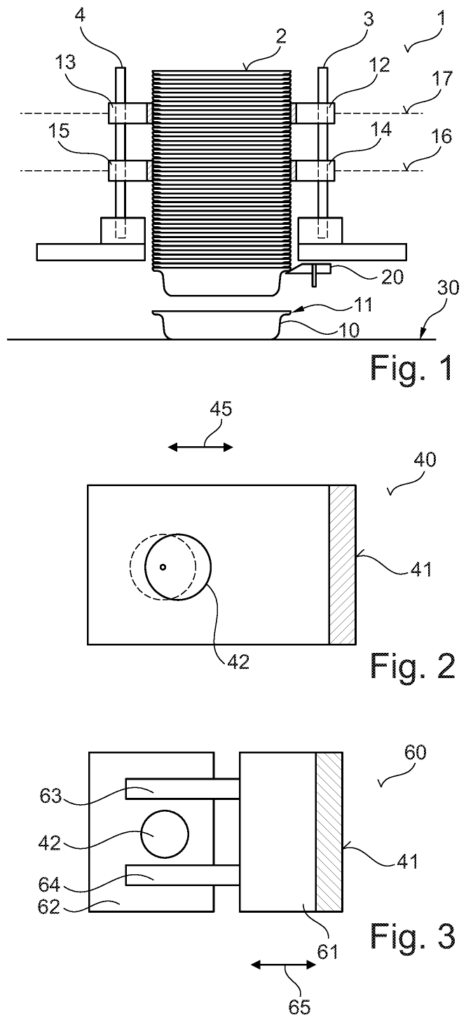

In FIG. 1 is schematically illustrated a support unit 1 suitable to be arranged in connection with a denesting apparatus in order to hold, guide and dispense trays 10 for example by means of a denesting wheel 20 unto a conveyor belt 30. The support unit supports and guides a stack of trays 2. In the illustrated embodiment the trays are illustrated by the lines symbolizing the edges 11 of the trays 10.

Two vertical guides 3, 4 are arranged in close proximity to the stack 2 on opposing sides of the stack. In this context opposing sides shall be understood as the vertical guides are arranged such that they when they urge the engagement pads towards the stack, they also urge the engagement pads towards each other. On each vertical guide 3, 4 are arranged two or more engagement pads, in this example two engagement pads 12, 13, 14, 15 on each vertical guide 3, 4. A first set of engagement pads 14, 15 is arranged at a first height indicated by the dashed line 16 and a second set of engagement pads 12, 13 is arranged at a second height indicated by the dashed line 17. It is clear that the first and second height 16, 17 are different such that the engagement pads are arranged on top of each other. In embodiments where more sets of engagement pads are provided, the additional sets will be arranged at different heights such as third, fourth etc. heights.

The engagement pads are constructed such that one set of engagement pads 14, 15 may be brought into contact with the edges 11 of the trays 10 while the other set 12, 13 is not in contact. In this situation all trays from the first height indicated by the dashed lines 16 are carried by the engagement pads and the trays below the first height 16 are carried by the denester wheel 20. By arranging the level of the engagement pads 14, 15 at a proper vertical distance from the denester wheel 20 it may be assured that the denester wheel 20 is not overloaded by the weight of the trays and at the same time is provided with sufficient free trays to dispense and denest and thereby dispense sufficient trays onto the conveyor belt 30 as desired by the production line.

Once the second set of engagement pads 12, 13 is engaged, the first set of engagement pads 14, 15 is retracted such that the stack of trays 2 will be carried by the second set of engagement pads 12, 13 at the second height 17. This will cause the trays 10 below the second height 17 to move downwards whereby a number of trays will pass the first height. Thereafter the first set of engagement pads 14, 15 is again activated whereby the engagement pads engage the stack of trays 2 and at the same time the stack is released by the second set of engagement pads 12, 13 and the routine starts over. This is furthermore elaborated with reference to FIG. 5. By engaging the first set of engagement pads 14, 15 and releasing the second set of engagement pads 12, 13 and vice versa repeatedly, very quickly the stack of trays 2 will be loosened and “rattle” downwards towards the denesting wheel 20. In the meantime while either the first set or the second set of engagement pads is engaging the stack, a very limited amount of trays will need to be carried by the denester wheel 20 and thereby the load on this denester wheel 20 is drastically reduced.

Turning to FIGS. 2 and 3, two different embodiments of the engagement pads 12, 13, 14, 15 are illustrated. In FIG. 2 an engagement pad 40 according to a first embodiment is illustrated. The engagement pad 40 is in this embodiment provided with a resilient pad 41 which will come into contact with the edges of the trays during operation. By making the engagement surface 41 resilient a number of advantages are achieved. The resiliency of the engagement pad 41 provides that any slide misalignments vertically will be compensated for by the resiliency such that the engagement pad will adapt to a slightly varying shape created by the plurality of tray edges being engaged by the engagement pads. In this manner the force of holding the stack will be substantially evenly distributed to a plurality of trays due to the resiliency of the engagement pad.

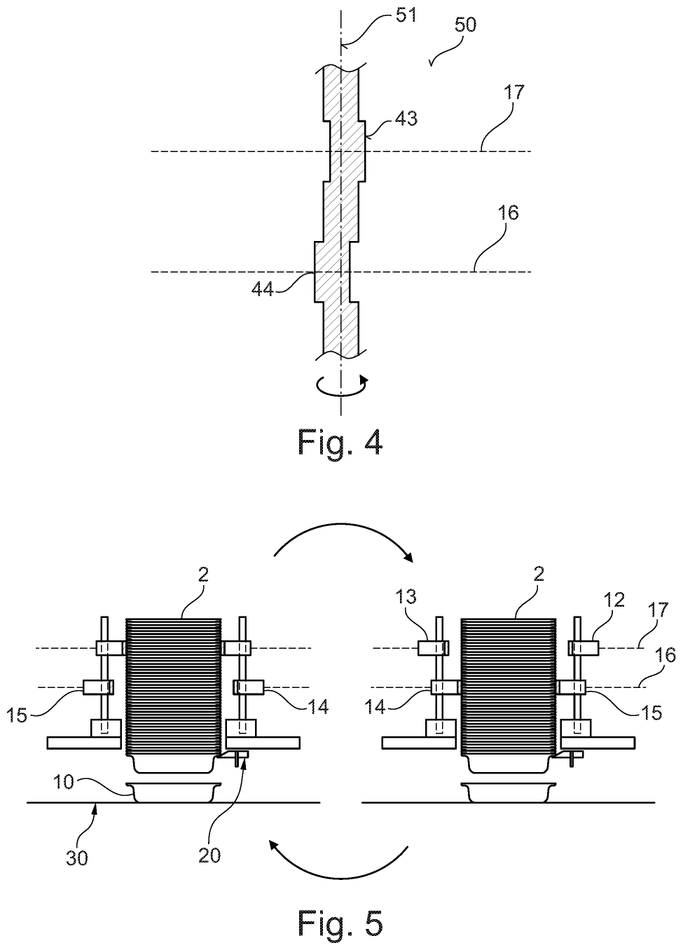

In order to activate the engagement pad from the first position to the second position as will be described below with reference to FIG. 5, an aperture 42 is provided in the body of the engagement pad. This aperture corresponds to a cross section through a drive axle as illustrated with reference to FIG. 4 and indicated by the dashed line 43. The drive axle 50, see FIG. 4, is illustrated schematically as a camshaft axle and by arranging the cam 43 in the aperture 42, rotation of the drive axle around the axis 51 will cause the engagement pad 40 to reciprocate back and forth as indicated by the arrow 45. Naturally, the engagement pad will be guided such that the camshaft does not only force the engagement pad in a random unguided pattern. Similarly, a second engagement pad may be arranged with a cam 44 at a first height 16 such that the engagement pads on one vertical guide reciprocates back and forth outer of sync whereby one engagement pad may be in contact with the stack 2 at all times whereas the other engagement pad is out of contact with the stack. By synchronising the two vertical guides in the shape of two vertical drive axles 50 corresponding to the guides 3 and 4 it is possible to achieve the effect where a set of engagement pads 14, 15 is in contact with the stack at one time at the first height 16 while a second set 12, 13 is out of contact at a second height 17 and vice versa. This is illustrated with reference to FIG. 5 where in the left hand stack, the first set of engagement pads 14, 15 is out of contact with the stack 2 whereas the second set of engagement pads 12, 13 arranged at the second height 17 is in engagement with the stack 2. At the same time the denester wheel 20 may denest trays 10 from the bottom end of the stack 2. In the right hand part of FIG. 5 the opposite situation has occurred namely when the lowest set of engagement pads 14, 15 at the first height 16 is in contact with the stack whereas the second set of engagement pads 12, 13 at a second height 17 is out of contact with the stack 20. By repeating this action again and again in a sequential manner only a small portion of the stack 2 will be carried by the denesting wheel whereas the major part of the stack will be carried by either the first set of engagement pads 14, 15 or the second set of engagement pads 12, 13.

Turning back to FIG. 3, another embodiment of the engagement pads' construction is illustrated. In this configuration the engagement pad 60 is generally in two separate parts 61, 62. The part of the engagement pad 60 suitable to come into contact with the edges of the trays 10 is again provided with a resilient surface 41. This is of course not mandatory but will provide additional advantages.

The two separate parts 61, 62 are connected by guides and actuator means 63, 64. The actuators may be synchronously activated in order to displace the part 61 relative to the other part 62 as indicated by the arrow 65. The central aperture 42 is provided in order to mount the engagement pad 60 on the vertical guides 3, 4 as illustrated in FIG. 1. The schematic illustration of the engagement pad 60 according to this embodiment is not provided with energy supply means dependent on the type of actuators 63, 64 used in the specific example. Naturally, by activating the actuators 63, 64 at the same time as the engagement pad arranged on the opposite side of the stack 2 at the same level 16, 17, the same effects as explained above with reference to FIGS. 1 and 5 will be achieved with engagement pads with this construction.

1. Support unit, constituting part of a denesting apparatus, said support unit supporting a stack of trays, cups or other receptacles to be denested in the denesting apparatus, such that trays, cups or other receptacles are dispensed one by one from a lower part of the stack, where said support unit comprises two vertical guides arranged in close proximity to the stack on opposing sides of said stack, and where on each vertical guide two or more engagement pads are provided, where a first set of engagement pads are arranged in a first holding position, and wherein actuation means are provided for bringing the engagement pads in said first holding position into contact with the edges of the trays, cups or other receptacles to be denested, and a second set of engagement pads are arranged in a second holding position wherein further actuation means are provided for bringing the engagement pads of the second set of engagement pads into contact with the stack of trays, cups or other receptacles to be denested, when the first set of engagement pads is not in engagement with the stack of trays, cups or other receptacles to be denested, such that the actuation means of the first holding position and second holding position operates sequentially such that only one set of engagement pads are in contact with the edges of the trays, cups or other receptacles to be denested.

2. Support unit according to claim 1, wherein said actuation means is in the shape of actuators provided for each engagement pad between the vertical guide and the surface of the engagement pad facing the stack of trays, cups or other receptacles to be denested.

3. Support unit according to claim 2, wherein the actuators are powered by hydraulic fluid.

4. Support unit according to claim 1, wherein the actuation means comprises at least one aperture in each engagement pad, where each vertical guide comprises a rotating axle, and where the axle is fitted through the at least one aperture in each engagement pad, and where a cross section of the rotating axle in the aperture has a non-circular cross-section and where the non-circular cross-section is different or non-symmetrical for engagement pads arranged on the same side of the stack of trays, cups or other receptacles to be denested.

5. Support unit according to claim 1, wherein said actuation means comprises at least one aperture in each engagement pad, where each vertical guide comprises a rotating axle rotating around a vertical axis, and where the axle is fitted through one aperture in each engagement pad arranged on the same side of the stack trays, cups or other receptacles to be denested, and where a section of the rotating axle is fitted in the aperture, where the cross-section of the section is circular, where the center of the circular section is off-centered relative to the longitudinal axis.

6. Support unit according to claim 1, wherein a sensor is provided for detecting vertical movement of the stack of trays, cups or other receptacles to be denested, such that if it is detected that the stack of trays, cups or other receptacles to be denested is moving upwards, the engagement pads are disengaged from contact with the stack of trays, cups or other receptacles to be denested.

7. Support unit according to claim 1, wherein the vertical guides are mounted on a moveable member, such that the movable member and thereby the vertical guide may be swung or slid away from the position where the engagement pads are able to contact the stack of trays, cups or other receptacles to be denested.

8. Support unit according to claim 1, wherein the vertical guides are arranged on a support element allowing the horizontal distance between the vertical guides to be adjusted.

9. Support unit according to claim 1, wherein the surface of the engagement pads intended for engagement with the stack of trays, cups or other receptacles to be denested is provided with a resilient layer.

10. Support unit according to claim 1, wherein the surface of the engagement pads intended for engagement with the stack of trays, cups or other receptacles to be denested are shaped corresponding to the edge of the trays, cups or other receptacles to be denested.

11. Method for denesting a tray, cup or other receptacle to be denested, where the denesting apparatus comprises means on which a stack of trays, cups or other receptacles to be denested are resting, said means may be a denesting wheel, where the stack of trays, cups or other receptacles to be denested is arranged in a support unit according to claim 1, where at least two engagement pads are arranged on each vertical guide, such that the first set of engagement pads is arranged at a first height and a second set of engagement pads is arranged at a second height different from the first height, and where:
in a first holding position the first set of engagement pads is in holding contact with the stack of trays, cups or other receptacles to be denested, and the second set of engagement pads is not in engagement with the stack of trays, cups or other receptacles to be denested; and a
second holding position where the second set of engagement pads is brought into holding contact with the stack of trays, cups or other receptacles to be denested, and the first set of engagement pads is not in engagement with the stack of trays, cups or other receptacles to be denested,
where during denesting, the denesting apparatus sequentially alters between the first holding position and the second holding position.

12. Support unit according to claim 2, wherein the actuators are powered by pressurized gas.

13. Support unit according to claim 2, wherein the actuators are powered by electricity.
